(19) United States
(12) Patent Application Publication
(10) Pub. No.: US 2009/0299760 A1
(43) Pub. Date: Dec. 3, 2009

(54) SYSTEM AND METHOD FOR MAXIMIZING THE EFFICIENCY AND EFFECTIVENESS OF NONPROFIT SCIENTIFIC AND OTHER RESEARCH

(75) Inventors: Dwayne H. Spradlin, Southlake, TX (US); Amiel M. Kornel, San Francisco, CA (US); Stephen M. McGrath, San Francisco, CA (US); Stafford Matthews, Tiburon, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: InnoCentive, Inc., Waltham, MA (US)

(21) Appl. No.: 12/395,944

(22) Filed: Mar. 2, 2009

Related U.S. Application Data
(60) Provisional application No. 61/033,004, filed on Mar. 2, 2008.

(51) Int. Cl. G06Q 10/00; G06F 15/16

(52) U.S. Cl. 705/1; 709/204

(57) ABSTRACT

A computer-implemented system for the exchange of proposed scientific and other research projects and the submission of solutions to such projects. The system facilitates the posting of proposed research projects and the submission of solutions to such projects prepared by interested researchers. The solutions are reviewed according to criteria specified by the research proposal, and, in the event the solutions are accepted, compensation may be paid to the researcher upon transfer of the intellectual property rights in the solution. Subsequent dissemination of the information to the public is also contemplated.

### RELATED APPLICATION

This application is a NONPROVISIONAL of, claims priority to and incorporates by reference U.S. Provisional Patent Application 61/033,004, filed Mar. 2, 2008.

### FIELD OF THE INVENTION

The present invention relates to computer-assisted methods and systems for use in connection with an open innovation accelerator for nonprofit scientific and other research, and, in particular, to a computer-implemented platform through which proposals and solutions of scientific and other research challenges for the benefit of the general public may be exchanged.

### BACKGROUND

Most nonprofit organizations do not have the resources or the expertise necessary to undertake or manage important scientific or other research projects. Such organizations are commonly understaffed; do not have the required scientific or technical expertise; have limited or no access to project management resources; have limited knowledge of intellectual property and licensing matters and legal issues relating to the protection and dissemination of such intellectual property; and are not experienced in or effective in utilizing the resources of the Internet to obtain the intended results or solutions from such proposed research. US Internal Revenue Service (IRS) regulations applicable to exempt nonprofit organizations further require that the results of any research, including any patents, copyrights, processes or formulas resulting from such research, generally be disclosed and made available to the public on a nondiscriminatory basis.

These major deficiencies result in a highly inefficient and sporadic means of sponsoring and funding scientific or other research initiatives by nonprofit foundations and other organizations. Nonprofit entities further require an efficient and managed means of protecting and licensing or otherwise distributing the results or solutions of such research in order to comply with the rules applicable to exempt organizations and to discharge their nonprofit purposes.

### SUMMARY OF THE DRAWINGS

In various embodiments, the present invention provides means and methods for posting proposed research projects via a computer-implemented exchange platform and receiving solutions to such projects via the exchange platform. Proposals concerning scientific or other research projects (which may generally include indicators by which completion of the respective projects are to be determined) are received and posted on the exchange platform for review by interested researchers. Thereafter, proposed solutions to the project are received from the researchers, and awards are transferred to those of the researchers associated with an accepted solution to the project. As a condition of the award (or engaging in the research), researchers are required to transfer intellectual property rights concerning the accepted solution. Ultimately, the solution(s) may be disseminated to the public (e.g., via the exchange platform).

In various instances, the exchange platform will be accessible via the Internet. Proposals may be received from nonprofit foundations or organizations, from a supervising organization acting for a client nonprofit foundation or organization or on its own behalf, from a science board convened by a supervising organization operating the exchange platform, and/or from members of the public. Generally, proposals are reviewed by a science board convened by a supervising organization operating the exchange platform prior to being posted for review by interested researchers. The reviewing organization may collaborate with the individual or entity proposing the project before it is posted.

In some cases, funding for the project(s) may be solicited via the exchange platform. For example, donations may be collected prior to the project proposal being posted via the exchange platform, after the project proposal has been posted via the exchange platform, after the project proposal has been accepted by one or more researchers, and/or after the solution for the project has been submitted. In some cases, prior to being posted via the exchange platform, a project proposal is submitted to an auction process to raise funds from one or more donors to support funding of research for the project proposal. Alternatively, the auction may take place after the project proposal is posted via the exchange platform, or in connection with multiple project proposals being submitted to the auction process. Bids from donors may be aggregated to support funding of research for one or more project proposals, and in some cases, aggregating bids from donors to support funding of research for one or more of the project proposals may be used in order to rank the project proposals in order of priority for applying funds raised during the auction process. These and other features and advantages of the invention are discussed further below.

### BRIEF DESCRIPTION OF THE DRAWINGS

The present invention is illustrated by way of example, and not limitation, in the figures of the accompanying drawings, in which:

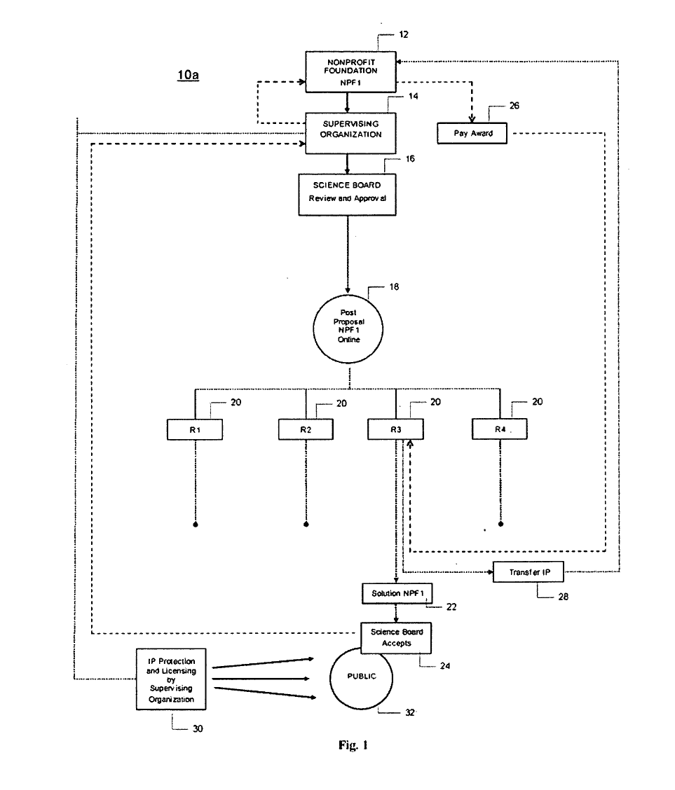

FIG. 1 illustrates one example of a computer-implemented exchange platform for the proposal of scientific and other research projects by nonprofit client foundations and other organizations and for the delivery of solutions to a proposed research project by researchers.

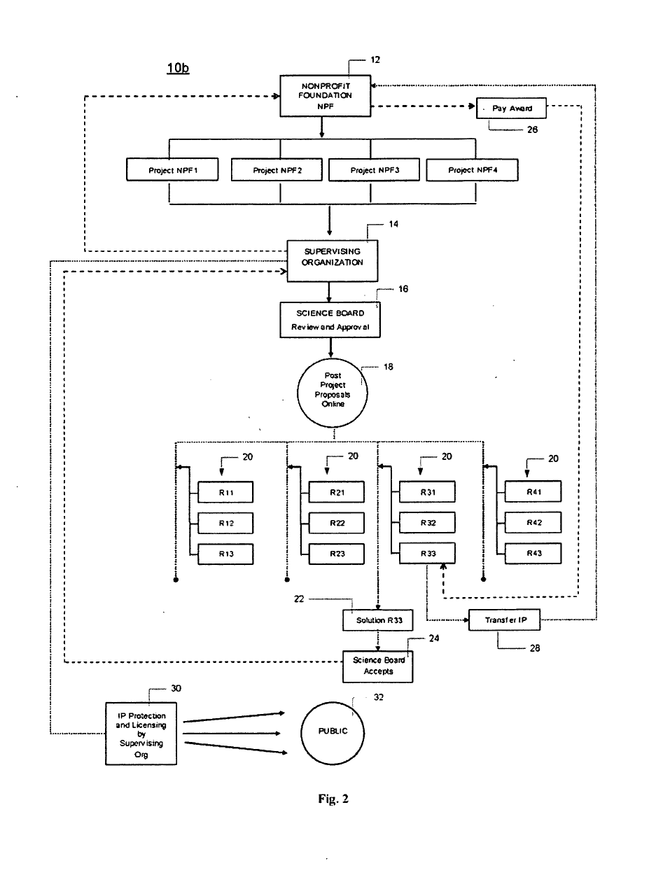

FIG. 2 illustrates a further embodiment of a computer-implemented exchange platform for the proposal of multiple scientific and other research projects by a nonprofit client foundation or other organization and for the delivery of solutions to such proposed research projects by researchers.

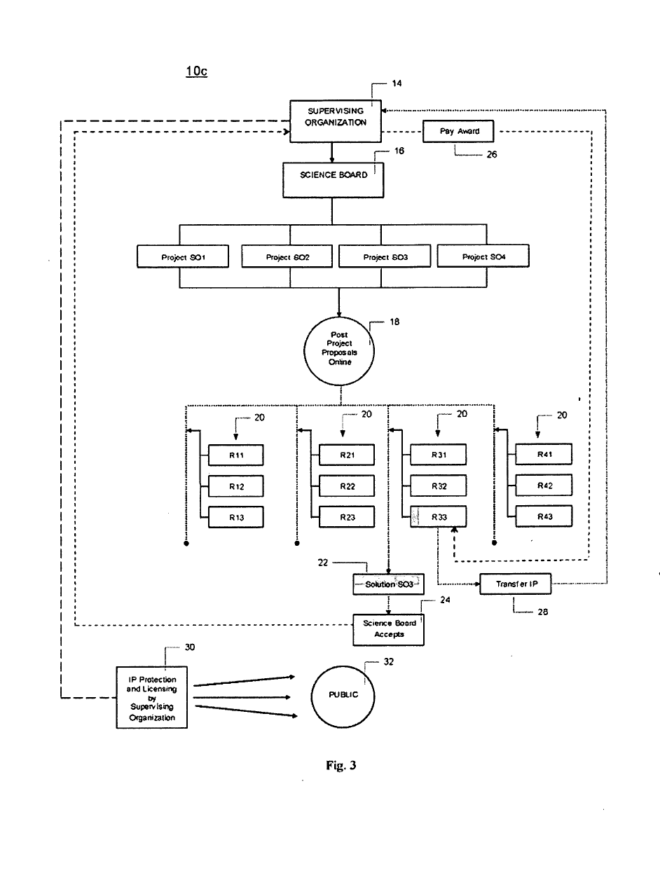

FIG. 3 illustrates another embodiment of a computer-implemented exchange platform for the proposal of scientific and other research projects as determined and proposed by a science board established in a particular field in order to obtain solutions from researchers.

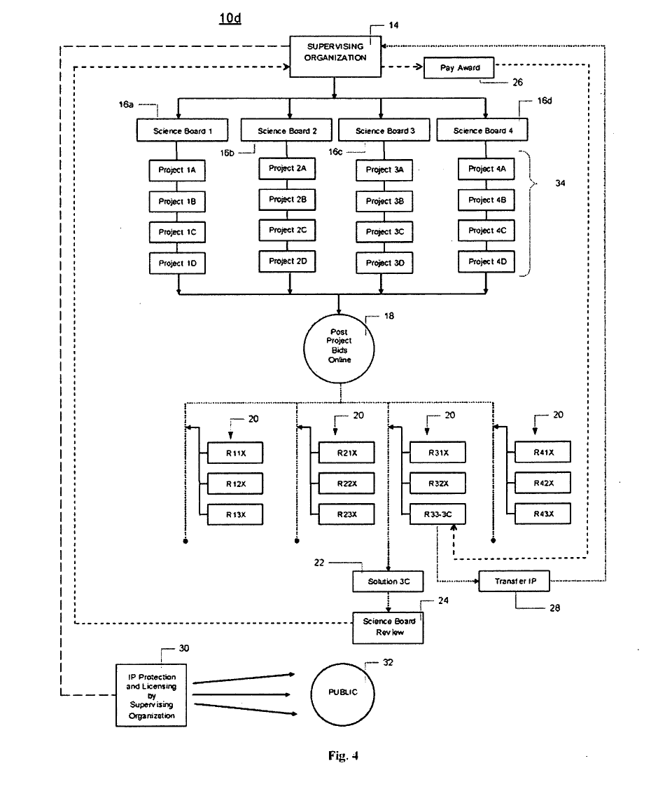

FIG. 4 illustrates still another embodiment of a computer-implemented exchange platform for the proposal of scientific and other research projects as determined and proposed by multiple science boards established in different fields in order to obtain solutions from researchers.

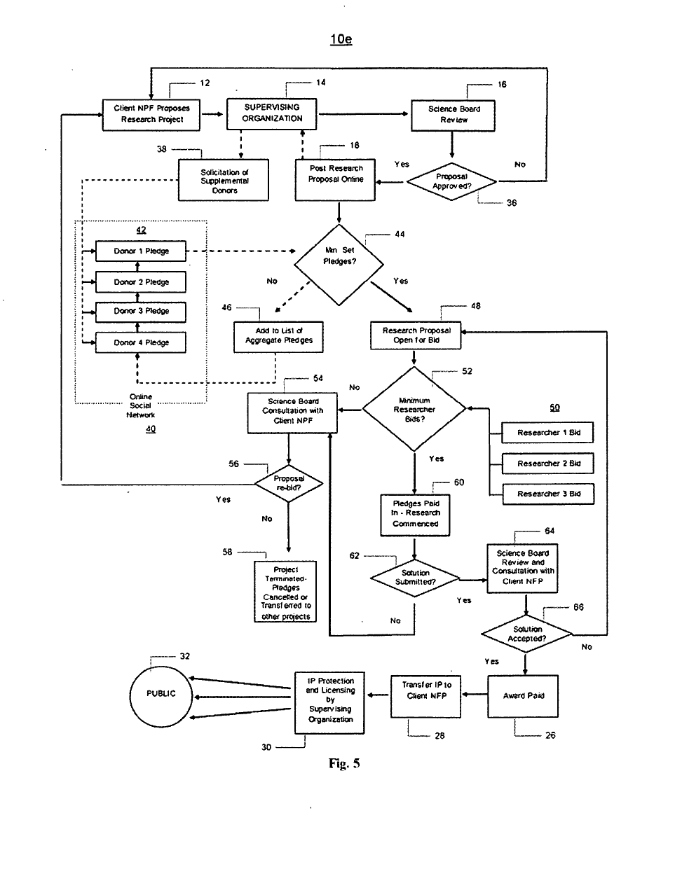

FIG. 5 illustrates yet a further embodiment of a computer-implemented exchange platform for the proposal of scientific and other research projects by nonprofit client foundations and other organizations and that provides for the solicitation and accumulation of supplemental funding for the projects.

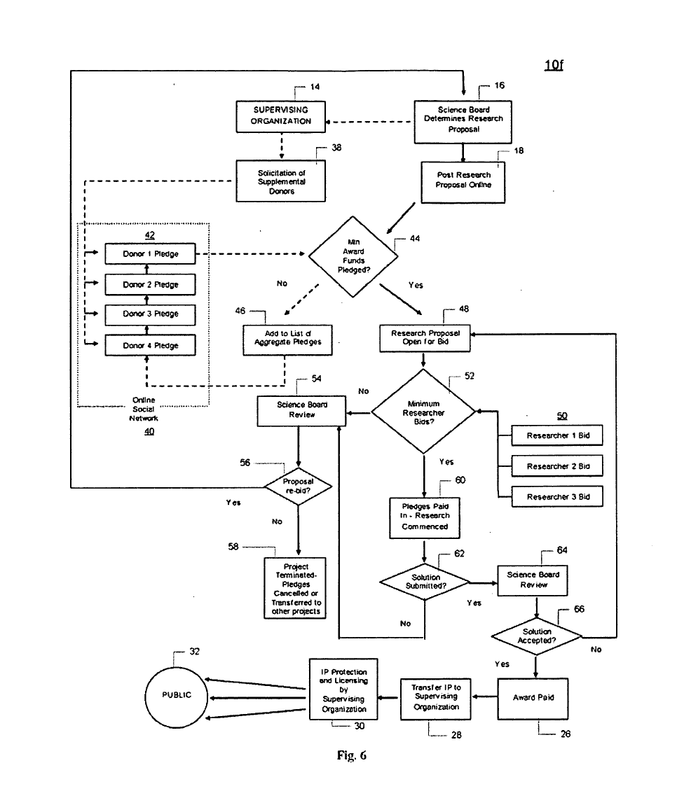

FIG. 6 illustrates still a further embodiment of a computer-implemented exchange platform for the proposal of scientific and other research projects as determined and proposed by a science board established in a particular field and that provides for the solicitation and accumulation of funding for the projects.

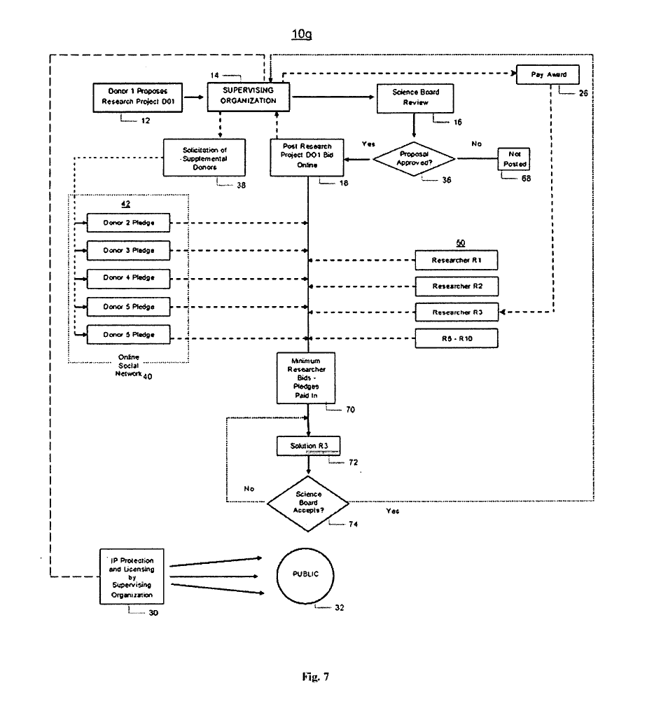

FIG. 7 illustrates still another embodiment of a computer-implemented exchange platform for the proposal of scientific and other research projects by donors or members of the public and that facilitates the solicitation and accumulation of funding for the projects and the matching of bids for solutions from researchers.

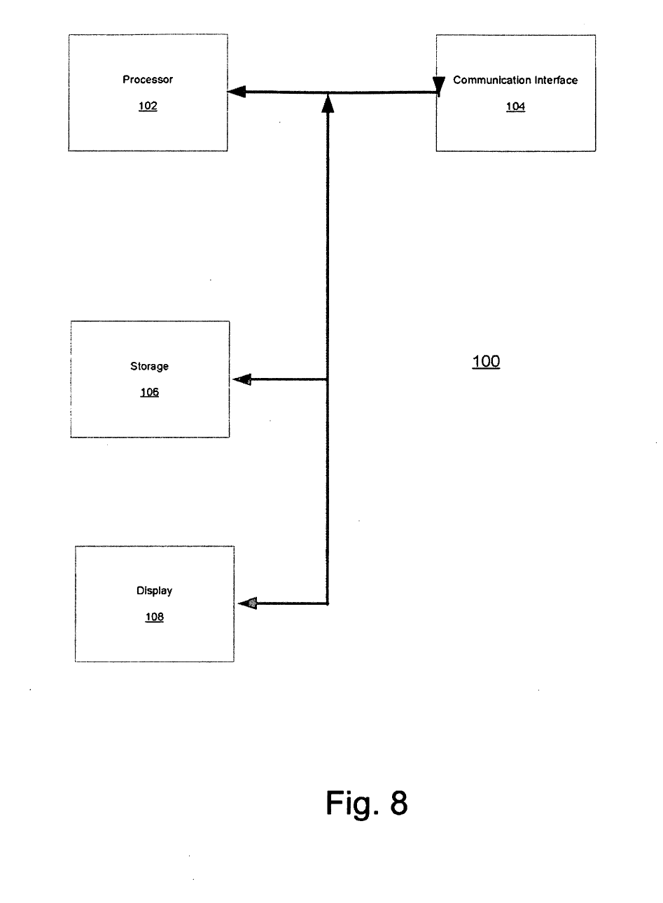

FIG. 8 illustrates an example of a computer platform suitable for hosting embodiments of the present computer-implemented exchange platform.

### DETAILED DESCRIPTION

In various embodiments, as discussed in detail below, the present invention provides an on-line exchange for nonprofit client foundations and organizations and others to propose scientific and other research projects for competition on a worldwide basis, and to facilitate the payment of awards (e.g., compensation and/or other consideration, such as attribution, etc.) to researchers that develop acceptable solutions to problems presented through such proposals. Proposals provided through the exchange may be distributed to a number of potential researchers (such as institutes, universities, consulting firms and other persons or entities engaged in relevant research) via postings to a web site or other accessible resource. The research projects may be in the fields of the physical sciences, engineering and design, chemistry, math and computer science, life sciences, business and entrepreneurship, or other disciplines. The researchers perform the research and receive remuneration through an open, competitive and performance-based award process. In various embodiments, the present invention further will permit individual and corporate donors to initiate or participate in the development and funding of the research projects.

Various embodiments of the present invention further provide for (1) management of the on-line exchange for client nonprofit entities and other participants; (2) expert review and evaluation of proposed or posted research projects and the results and solutions of related research, (3) reporting of transactions that take place through the exchange, (4) the exchange of information, thereby linking internal and external (e.g., third-party) resources relevant to the fields of subject research; and (5) systematic protection and use of the results and solutions of such research, including all intellectual property rights in such results and solutions, for the principal benefit of the general public. The present invention thus represents an integrated, “turn key” solution for nonprofit scientific and other research projects. An example of such an on-line exchange platform is shown in FIG. 1, which is discussed in further detail below. In one embodiment, the on-line exchange platform will be established and operated by a nonprofit, charitable corporation qualified as a tax exempt organization pursuant to Sections 501(c)(3) of the United States Internal Revenue Code (as amended or superseded) or under other laws governing nonprofit entities in the relevant jurisdiction (“Supervising Organization”).

In some embodiments of the invention, a nonprofit foundation or organization client will identify and prepare the specifications for the scientific or other research project to be performed, and will post the research project for bid on the on-line exchange. Such nonprofit foundation or organization clients could include, for example, private funds or foundations such as the Ford Foundation, public affiliation organizations such as the American Heart Association or the National Parkinson Foundation, and donor-advised funds affiliated with a bank or financial institution, such as the Vanguard Charitable Endowment Program. As a condition for posting projects via the exchange, the foundation or organization may be required to enter into a legally binding contract with the Supervising Organization regarding the management of the proposed project. Further, the proposal may be reviewed by a qualified person or persons, such as a science board in the relevant field established by the Supervising Organization. An example of this system is shown in FIG. 2 and discussed further below.

In some instances, the nonprofit client foundation or organization and the Supervising Organization may collaborate in the determination and preparation of the specific scientific or other research project bid to be posted on the exchange. Alternatively, the Supervising Organization may establish or use separate, intermediating or “buffer” nonprofit or other entities in connection with the posting and conduct of specific scientific or other research projects. In any event, the on-line exchange provides means for interactive on-line intake of project proposals, as well as means for development of those proposals, and analytical and communication tools to assist nonprofit foundations or other organizations in preparation of their project proposals.

In some cases, the Supervising Organization will directly develop, determine and prepare the specific scientific or other research project bid(s) to be posted on the exchange. This may be done in collaboration with one or more science boards established by the Supervising Organization. Alternatively, such science boards may directly develop and determine and prepare scientific or other research project proposals to be posted on the exchange. An example of this variant is shown in FIG. 3 and discussed further below. The use of multiple, independent science boards established in different fields permits the simultaneous proposal of multiple scientific and other research projects as determined and proposed by each of such board in order to obtain solutions a wide variety and number of researchers. An example of this approach is shown in FIG. 4 and discussed further below.

Proposed research projects will be posted via the on-line exchange and made available via the Internet (e.g., at a designated web site or sites hosted a one or more servers). Each project may be presented in the form of an offer and request for performance by interested researchers. Individual project bids will be open to all qualified researchers, and the positing may include a description of the qualifications required. Whereas some, perhaps many, projects will be open to any interested researcher, it is envisioned that other projects may be limited to researchers having certain qualifications. The posting will describe any such necessary qualifications, if any, as well the objectives and specifications for the research project, other key performance indicators, the intended results or solutions of the project, and other relevant information. The posting also will set forth the terms and conditions for the award(s), if any, to be paid for the satisfactory completion of the research project.

In various embodiments of the invention, awards for successfully completed research projects will be paid on a performance award and contingent basis, conditioned upon the satisfactory delivery of a solution of the research project as a whole, or the completion of one or more specified milestones, by one or more researchers (e.g., working jointly or independently). The “winner(s)” of the performance based award under this scheme would be the first researcher(s) to deliver the required solution to the satisfaction of the sponsoring nonprofit foundation or organization and/or the Supervising Organization.

Other projects may be let and awards paid on different terms. For example, some research project proposals may be in the form of an offer for a fixed price or terms contract which may be accepted by one or more specific researchers to the exclusion of other researchers. In other cases, the research project proposals may be in the form of an offer for a variable or minimum price or terms contract based on external criteria such as the amount of funds raised from donors for the financing of the project.

In some instances, all or certain classes of solutions submitted by researchers will be reviewed and evaluated by the relevant science board prior to determination of the award. In the event no satisfactory solution of the research project is delivered by one or more researchers, the project may be terminated. Alternatively, the Supervising Organization or the relevant science board may reconfigure and re-post the research project or may develop and determine, and prepare and post an alternative research project. An example of this situation is shown in FIG. 5 and described further below.

As may now be apparent, the present exchange platform permits the democratization of nonprofit scientific or other research initiatives by creating an interactive auction process for the “bottom up” promotion, ranking and funding of specific research projects. In some embodiments of the invention, financial support for projects can be raised via the exchange through the direct solicitation and collection of individual or group donations from members of the general public seeking to affiliate with the client organization or the Supervising Organization as funding “co-sponsors” or “partners”. An example of such solicitation is shown in FIG. 5.

As shown, client organizations may use the exchange platform to raise funds for a research initiative from a much larger potential donor base than that of its own general membership, while permitting potential donors to maximize the effect and efficiencies of their financial participation by targeting an independently managed and defined research project instead of funding an organization as a whole. In one embodiment of the invention, additional financial support for a research initiative may be raised in the form of matching company and/or employee payroll deductions, or in the form of a percentage of revenues or profits of the donor person or entity, or by other means. The amount of supplemental or participating funds raised for a project may be limited to an incremental or total fixed amount established for the project or may be unlimited. Such funds may be deductible for U.S. or other income tax purposes to the extent permitted by applicable law, and will be held and used by the Supervising Organization as part of the funding for the specified research project of the client foundation or organization. If no solution to a posted research project is produced and delivered within the specified parameters for the project, then funds intended for the associated award may be granted to the sponsoring client organization (less administrative fees) or retained by the Supervising Organization.

One embodiment of the invention includes a computer-based interactive means of collaboration by interested donors and supporting organizations and other members of the public regarding proposed research projects through use of an Internet blog or message board or other form of social networking associated with the research project, in part in order to permit the solicitation of additional donors or other support for the subject projects, and the affiliation of such donors with each other and with the client nonprofit organization.

In some instances, private individual or corporate donors or other members of the public may directly propose or post scientific or other research project bids via the exchange platform under contract with the Supervising Organization and in a similar manner as nonprofit foundations or organizations.

In another embodiment of the invention, donors and other interested members of the public may rank the importance and urgency of potential research projects posted via the exchange through an interactive “voting” system. In such instances, the Supervising Organization, either directly or through the actions of a relevant science board, may post a series of potential research proposals via the on-line exchange, which proposals seek the cumulative financial support of the public for a fixed award amount. An example of this process is shown in FIG. 6 and described further below. Each research proposal will become effective and open for bid by researchers when the fixed amount for the award is collected from donors.

In another aspect of the invention, the on-line exchange platform includes an information exchange, linking internal and external resources relevant to the subject fields of research.

In instances where potential research projects are submitted by members of the public for consideration and possible posting by the Supervising Organization, persons submitting the potential research projects that are ultimately posted by the Supervising Organization and fully funded by public support may be paid a fee in exchange for the successful submission.

In another embodiment of the invention, a multiple-stage process for the direct public development and posting of appropriate proposed scientific or other research initiatives using an auction based process is provided. An example of this donor-based development and auction process is shown in FIG. 7 and described further below. In the first stage of the process, any individual or corporate donor or organization or other member of the public (collectively “donor”) can directly propose specific scientific or other research initiatives by posting the proposed project for possible public support and auction on the exchange. The objective of this stage of the process is to maximize the number of potential posted research projects. The project bid would include a description of the project and other relevant terms and conditions. The donor may be required to deposit or otherwise commit a minimum, “good faith” contribution as a condition of the bid in order to eliminate frivolous proposals. Such deposited or committed amounts may be returnable to the donor after a predetermined period of time (less an administrative fee) if the project is not confirmed. Alternatively, the contribution may be retained by the Supervising Organization on a restricted or unrestricted basis.

Generally, the Supervising Organization will have the right to review and either approve or reject the posting of any research proposal from a donor, and no submissions would be confidential. Any intellectual property contained in the proposal or in the results or solutions of any research would be held by the Supervising Organization or transferred to another appropriate nonprofit organization. One embodiment of the invention provides a system and method for providing interactive, on-line intake and development of such project proposals, and analytical and communication tools to assist the donors in the preparation of bids. Through the exchange, donors may be able to access (1) reports concerning the status of the research project(s) and the funds raised in support thereof, and (2) information concerning the subject matter of the research project or the field of which the project is a part.

In the next stage of the process, any approved bid from a donor is published for auction via the exchange platform. The objective of this stage of the process is to determine, by use of an auction procedure, whether a zone of potential agreement exists between “buyers” of the particular research project (the donors) and “sellers” of the research (potential researchers).

Following the posting of a project proposal, interested donors may bid and aggregate financial support for the research project. All bids would be binding and may be secured by use of a credit card or other automatic payment mechanism to ensure full payment of the commitment. In some cases, a computer-based, interactive means of collaboration by interested donors and supporting organizations and other members of the public regarding a proposed research project may take the form of an Internet blog or message board or other form of social networking tool associated with the research project, in part in order to permit (1) the solicitation of additional donors or other support, (2) the affiliation of such donors with each other or with relevant “affiliation” nonprofit organizations or third persons or entities, (3) active public comment concerning the subject matter or specifications of the proposed research, and (4) a dynamic collaborative “build” of the project by donors and others.

In parallel with the donor bidding (or following an indication that a certain level of funding for a project has been reached), interested researchers may submits bids on the research project via the exchange platform. In particular, a researcher may express an indication as to the minimum award for the project deemed acceptable by the researcher for the completion of the research project. These “seller” bids represent binding commitments of the researcher to undertake the research project in good faith if the minimum award level is reached. Under the auction procedure these bids are compared to and matched with the committed funds pledged by the “buyer” donors and organizations for the project.

In the next stage of the process, the research project will be confirmed and becomes effective when the bids of a predetermined minimum number of researchers are matched with the award amounts for the project committed by the donors under the auction procedure. At that time, donor pledges may be funded (e.g., by charging credit cards or debiting bank accounts, etc.) and a project fund established by the Supervising Organization for the conduct of the research project. The research project will then be conducted in accordance with the project protocols described in the proposal and the research award paid on a competitive and performance based contingent award basis.

If the research project is not successfully completed within an allocated period of time (e.g., as specified in the project proposal), the project may be terminated or the relevant science board may reconfigure the research project or develop and determine and prepare an alternative research project. If the project is terminated, then the funds raised in the auction process may be (i) retained by the Supervising Organization for use in funding one or more future research projects in the same or another field as determined either in collaboration with or solely by the relevant science board, or (2) granted to another nonprofit organization with an appropriate connection to the subject matter of the research project as determined by the Supervising Organization or the relevant science board.

In one embodiment of the invention, the Supervising Organization may manage all intellectual property rights resulting from the research projects. The Supervising Organization may direct the preparation and filing of applicable applications or other registrations for all intellectual property rights (including patent applications and copyright registrations) on behalf of the relevant nonprofit client foundation and other organization in the case of completed client research projects. The Supervising Organization may also direct the preparation and filing of such applications or registrations on its own behalf in the case of completed research projects sponsored directly by the Supervising Organization or by the donor public. This function is shown in FIGS. 1-7 and discussed further below. In some cases, the exchange platform itself may include means for interactively preparing and filing the applications or other registrations for any intellectual property rights embodied in the results or solution of the completed the research project.

Pursuant to agreements with the client nonprofit organization, the Supervising Organization may oversee or administer the disclosure, licensing or other dissemination of the results of the completed research projects (e.g., in compliance with the above-mentioned IRS guidelines and with the objective of maximizing the public disclosure and dissemination and use of the results) on appropriate financial and other terms and conditions. The exchange platform itself may include means for providing and obtaining disclosure and dissemination and licensing of the results or solution of the completed research projects. Further, the Supervising Organization may prosecute all intellectual property infringement or misappropriation claims and other intellectual property claims either on behalf of the client nonprofit foundations or organizations or on its own behalf or on behalf of their respective licensees.

Before further describing the examples of the present exchange platform introduced above, reference is made to FIG. 8, which shows a computer platform 100 suitable for hosting embodiments of the exchange. Platform 100 may be a computer system suitably programmed to perform the functions described herein which are associated with the present exchange. As used herein, the terms computer system and computing system are broadly used to describe a computing device that can store and independently run one or more programs, applications, scripts, or software processes/routines. Such computer systems are characterized by one or more processors 102, which are configured to read and execute computer-executable instructions in order to carry out tasks defined by those instructions. The computer-executable instructions (i.e., programs or routines) may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (COBRA), Java™ and the like. In general, all of the aforementioned terms as used herein are meant to encompass any series of logical steps performed in a sequence to accomplish a given purpose. Implementations of the present invention may be hosted on a single computer system 100 or any number of such computer systems.

Computer system 100 may communicate with other computer systems/devices via a communication interface 104. The communication interface may provide the ability to transmit and receive signals, such as electrical, electromagnetic or optical signals, that include data streams representing various types of information (e.g., messages, communications, instructions, and data). The communication interface may provide an implementation for a communication protocol. Instructions may be executed by the processor upon receipt and/or stored in storage 106, accessible to the processor.

Storage 106 may be any form or combination of computer-readable medium, including random access memory (RAM) or other dynamic storage devices, for storing dynamic data and instructions executable by the processor, read only memory (ROM), hard disk, solid state drive, and optical disk, or other form of storage media. An optional display 108 may be provided, but often in the case of a server will not be present.

Turning now to FIG. 1, a first example of the present computer-implemented exchange platform 10a is shown. In this embodiment, a nonprofit foundation or other organization 12 submits a proposed research project (NPF 1) via the hosted exchange. The project proposal is received by the Supervising Organization 14 and provided to its science board 16 for review and approval. Once approved, the proposal is posted (18) to the exchange for public viewing.

Responsive to the posting of the proposal, researchers R (20) can view same and, as shown in the illustration, a researcher that produces a solution 22 can submit same via the exchange. The solution will be reviewed by the science board and, if accepted, 24, the Supervising Organization will be notified and will instruct the sponsoring organization to pay the appropriate award 26. As mentioned above, the awards may be monetary compensation and/or other consideration, such as attribution, recognition, etc.

As discussed above, in exchange for the award (or otherwise according to the terms of the proposal), the researcher will transfer the intellectual property rights in the solution to the sponsoring organization and/or the Supervising Organization 28, and the Supervising Organization will attend to the securing of intellectual property rights 30 and dissemination of the information to the public 32.

FIG. 2 illustrates an alternative example of the present computer-implemented exchange platform 10b. In this example, the nonprofit organization 12 has submitted multiple research proposals NFP1-NFP4, which are reviewed and processed in the manner discussed above. Any or all of the proposals may be accepted and posted on the exchange, and for those that are so accepted and posted, researchers may provide solutions and receive awards as discussed above. Awards, intellectual property rights and dissemination of information to the public is as described above.

FIG. 3 illustrates yet a further example of the present computer-implemented exchange platform 10c. In this example, the science board 16 makes several project proposals SO1-SO4, which are posted via the exchange. Researchers may provide solutions and receive awards as discussed above. Awards, intellectual property rights and dissemination of information to the public is handled by the Supervising Organization 14, as described above.

FIG. 4 illustrates yet a further example of the present computer-implemented exchange platform 10d. In this example, multiple science boards 16a-16d each make various project proposals 34, which are posted via the exchange. Researchers may provide solutions and receive awards as discussed above. Awards, intellectual property rights and dissemination of information to the public is handled by the Supervising Organization 14, as described above.

FIG. 5 illustrates an example of the present computer-implemented exchange platform 10e configured to facilitate the solicitation of donor pledges and researcher bids, as described above. In this instance, a nonprofit or other organization 12 submits a proposal through the exchange to the Supervising Organization 14, and the proposal is passed to the science board 16 for review and approval. If approved, 36, the proposal is posted on the exchange (18), otherwise it is rejected.

For those proposals which are accepted and posted to the exchange, the Supervising Organization solicits donor pledges to fund the project 38. This may be done via social network tools 40 inherent to the exchange or to external systems, and the donors 42 may make pledges that are associated with the research project. In this example, pledges are accepted to at least a minimum aggregate amount 44, with each pledge being tallied towards the total, 46. Once the minimum project funding level has been reached, the project is opened to bids by researchers 48.

Researchers 50 submit bids (e.g., amounts for which they will undertake the project). A comparison 52 is made to determine if a researcher has agreed to undertake the research for the amount pledged by the donors. If not, the science board, in consultation with the sponsoring organization, may review the project, 54, and determine whether or not to re-bid the proposal 56. If so, the process repeats with a revised proposal. Otherwise, the project may be terminated and the donor pledges cancelled or transferred to other projects 58. Otherwise, if a researcher has agreed to perform the research for an amount equal to (or less than) the pledged amounts, the pledges are committed 60.

If, after a period of time, no solution is submitted, the science board may consult with the sponsoring organization and decide whether or not to terminate the project. However, if a solution is submitted, 62, then the science board, in consultation with the sponsoring organization, will review the solution 64, and, if it is accepted, 66, the award will be paid, intellectual property rights transferred and the information disseminated to the public, as discussed above. If the solution is not accepted, the project may be put back up for bid by researchers.

FIG. 6 illustrates a variation of the scheme shown in FIG. 5. This time, the exchange 10f is configured so that the science board 16 determines the project proposals. Otherwise, the overall flow is as discussed above with reference to FIG. 5.

FIG. 7 yet a further example of an exchange 10g configured according to an embodiment of the invention. In this example, which is for a donor-submitted proposal but could equally be applied to a Supervising Organization submitted proposal or a science board submitted proposal, if the project is approved, 36, the Supervising Organization solicits donations, 38, as discussed above and researchers 50 bid the project substantially in parallel. Of course, if the project is not accepted by the science board it is not posted 68.

Assuming the project is accepted and posted and the donations and researcher bids are solicited, then the pledges and bids are matched 70 and solutions 72 reviewed 74 until one solution is accepted by the science board. At that point, the awards are paid, intellectual property rights transferred and the information disseminated to the public, as discussed above.

The foregoing description of illustrated embodiments of the invention is not intended to be exhaustive or to limit the invention to the precise forms disclosed. The teachings of the invention provided herein can be applied to other systems, not necessarily described above but which will be apparent to those of ordinary skill in the art upon reading the foregoing materials. Furthermore, the various embodiments described above can be combined to provide further embodiments. Accordingly, the invention should be measured only in terms of the claims, which follow.

What is claimed is:

1. A method for posting proposed research projects and receiving solutions to such projects, the method comprising:
receiving, via an exchange platform configured to facilitate the posting of said research projects, a proposal concerning a scientific or other research project which proposal includes at least one indicator by which completion of the project is to be determined,
posting, on the exchange platform, the project proposal for review by interested researchers;
receiving, via the exchange platform from one or more of said researchers, proposed solutions to the project; and
transferring, via the exchange platform, an award to one or more of the researchers associated with an accepted solution to the project upon transfer of intellectual property rights concerning the accepted solution, the accepted solution being one that has undergone evaluation to determine whether the project has been satisfactorily completed.

2. The method of claim 1, further comprising disseminating, via the exchange platform, the accepted solution to the public.

3. The method of claim 1 wherein the exchange platform is accessible via the Internet.

4. The method of claim 1 wherein the proposal is received from a nonprofit foundation or organization.

5. The method of claim 1 wherein the proposal is received from a supervising organization acting for a client nonprofit foundation or organization or on its own behalf.

6. The method of claim 1 wherein the proposal is received from a science board convened by a supervising organization operating the exchange platform.

7. The method of claim 1 wherein the proposal is received from a member of the public.

8. The method of claim 1 wherein the proposal is reviewed by a science board convened by a supervising organization operating the exchange platform prior to being posted for review by interested researchers.

9. The method of claim 1 wherein a reviewing organization collaborates with an individual or entity proposing the project regarding aspects of the project.

10. The method of claim 1 further comprising soliciting, via the exchange platform, financial support for funding of the project from one or more donors.

11. The method of claim 10 further comprising collecting donations prior to the project proposal being posted via the exchange platform.

12. The method of claim 10 further comprising collecting donations after the project proposal has been posted via the exchange platform.

13. The method of claim 10 further comprising collecting donations after the project proposal has been accepted by the one or more researchers.

14. The method of claim 10 further comprising collecting donations after the solution for the project has been submitted.

15. The method of claim 1 wherein, prior to being posted via the exchange platform, the project proposal is submitted to an auction process to raise funds from one or more donors to support funding of research for the project proposal.

16. The method of claim 1 wherein, after being posted via the exchange platform, the project proposal is submitted to an auction process to raise funds from one or more donors to support funding of research for the project proposal.

17. The method of claim 1 wherein multiple project proposals are submitted to an auction process to raise funds from one or more donors to support funding of research for one or more of the project proposals.

18. The method of claim 17 further comprising aggregating bids from donors to support funding of research for the one or more project proposals.

19. The method of claim 17 further comprising aggregating bids from donors to support funding of research for one or more of the project proposals in order to rank said project proposals in order of priority for applying funds for said project proposals.

20. A computer-based exchange platform for posting proposed research projects and receiving solutions to such projects, the exchange platform comprising:
means for receiving a proposal concerning a scientific or other research project which proposal includes at least one indicator by which completion of the project is to be determined;
means for posting the project proposal for review by interested researchers;
means for receiving, from one or more of said researchers, proposed solutions to the project;
means for transferring compensation to one or more of the researchers associated with an accepted solution to the project upon transfer of intellectual property rights concerning the accepted solution, the accepted solution being one that has undergone evaluation to determine whether the project has been satisfactorily completed.

21. The computer-based exchange platform of claim 20, further comprising means for disseminating the accepted solution to the public.
